(19) United States
(12) Patent Application Publication
(10) Pub. No.: US 2010/0123629 A1
(43) Pub. Date: May 20, 2010

(54) Dual-Polarized Antenna

(75) Inventors: Chien-Hung Lin, Taipei Hsien (TW); Lan-Yung Hsiao, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/271,130

(22) Filed: Nov. 14, 2008

(51) Int. Cl. H01Q 1/38

(52) U.S. Cl. 343/700 MS

(57) ABSTRACT

A dual-polarized antenna includes a grounding plate, a vertically polarized portion and a horizontally polarized portion. The vertically polarized portion has a first connecting portion extending from one edge of the grounding plate, a vertical radiating element spaced at the edge for forming a simulation capacitance therebetween, and a first feeding portion connected to the first connecting portion and the vertical radiating element. The horizontally polarized portion has a second connecting portion extending from another edge of the grounding plate substantially perpendicular to the edge of the grounding plate, a horizontal radiating element spaced at the another edge for forming another simulation capacitance therebetween, and a second feeding portion connected to the second connecting portion and the horizontal radiating element. The two simulation capacitances help to adjust bandwidth and input impedance of the dual-polarized antenna for improving the gain of the dual-polarized antenna.

### BACKGROUND OF THE INVENTION

1. Field of the Invention

The present invention relates to an antenna, and more particularly to a dual-polarized antenna.

2. The Related Art

In recent years, portable communication devices are becoming progressively popular. In order to communicate with the outside world, various antennas are assembled in these devices for transmitting and receiving electromagnetic waves. Dual-polarized antenna is just a category among the varied antennas. A known dual-polarized antenna adopts two pairs of half-wave oscillators symmetrically arranged in a substantially cross-shaped structure to realize orthogonal magnetic field between the two pairs of the half-wave oscillators and achieve double polarization.

However, the above known dual-polarized antenna is by means of two couples of half-wave oscillators to perform communication function, the structure of the dual-polarized antenna is simple, but the gain of the dual-polarized antenna is also correspondingly reduced, which affects the efficiency of the dual-polarized antenna.

### SUMMARY OF THE INVENTION

It is an object of the present invention to provide a dual-polarized antenna having an improved gain. The dual-polarized antenna includes a grounding plate, a vertically polarized portion and a horizontally polarized portion. The vertically polarized portion has a first connecting portion extending from one edge of the grounding plate, a vertical radiating element spaced at the edge for forming a simulation capacitance therebetween, and a first feeding portion connected to the first connecting portion and the vertical radiating element. The horizontally polarized portion has a second connecting portion extending from another edge of the grounding plate substantially perpendicular to the edge of the grounding plate, a horizontal radiating element spaced at the another edge for forming a simulation capacitance therebetween, and a second feeding portion connected to the second connecting portion and the horizontal radiating element.

As described above, a simulation capacitance is respectively formed between the vertical radiating element and the grounding plate, and the horizontal radiating element and the grounding plate, which can adjust bandwidth and input impedance of the dual-polarized antenna for improving the gain of the dual-polarized antenna.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a dual-polarized antenna in accordance with the present invention;

FIG. 2 is a partial enlarged view of a first feeding portion of the dual-polarized antenna labeled IX shown in FIG. 1; and

FIG. 3 is a vertical view of the dual-polarized antenna shown in FIG. 1.

### DETAILED DESCRIPTION OF THE PREFERRED EMBODIMENT

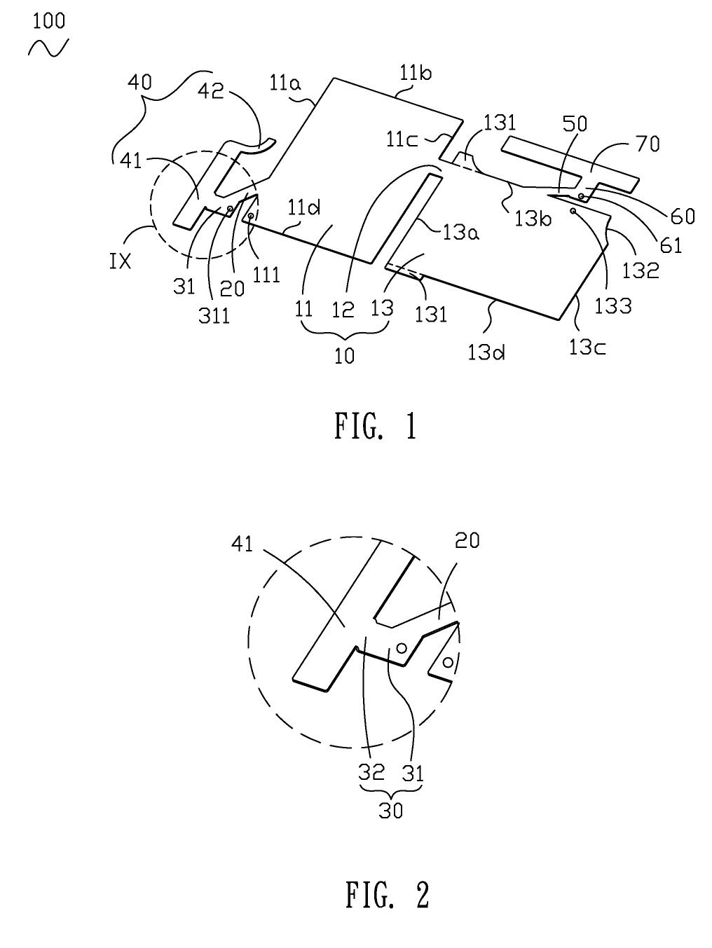

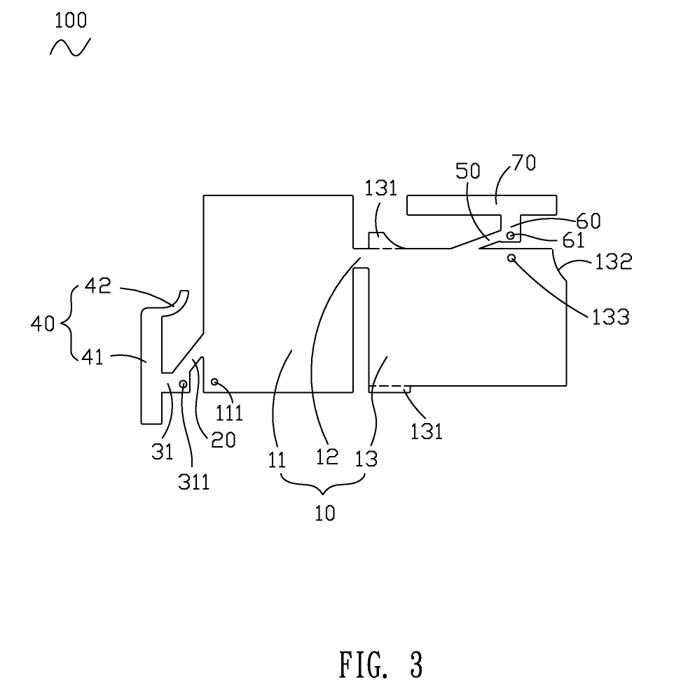

With reference to FIGS. 1 to 3, a dual-polarized antenna 100 according to the invention includes a grounding plate 10, a vertical radiating element 40 spaced at one edge of the grounding plate 10 and a horizontal radiating element 70 spaced at another edge of the grounding plate 10 substantially perpendicular to the edge of the grounding plate 10.

The grounding plate 10 includes a first grounding plate 11, a second grounding plate 13 spaced at the first grounding plate 11 and a narrow linking portion 12 connecting the first grounding plate 11 with the second grounding plate 13.

The first grounding plate 11 is of substantially rectangular shape and has two opposite first and second longitudinal edges 11a, 11c, and two opposite top and bottom transverse edges 11b, 11d substantially perpendicularly connected to the first and second longitudinal edges 11a and 11c. The first grounding plate 11 has a first grounding point 111 positioned at a corner formed by the first longitudinal edge 11a and the bottom transverse edge 11d. A first connecting portion 20 extends outward and inclines towards the bottom transverse edge 11d from a lower position of the first longitudinal edge 11a which is near the first grounding point 111.

The vertical radiating element 40 has a substantially rectangular shaped vertical radiating section 41 spaced at the first longitudinal edge 11a of the first grounding plate 11. A top end of the vertical radiating section 41 has a cambered radiating section 42 bent towards the first longitudinal edge 11a. A bottom end of the vertical radiating section 41 exceeds the bottom transverse edge 11d of the first grounding plate 11.

A first feeding portion 30 arranged between the vertical radiating element 40 and the first connecting portion 20 for connecting the vertical radiating element 40 with the first connecting portion 20. The first feeding portion 30 has a base 31 extending towards the vertical radiating section 41 from a free end of the first connecting portion 20 and a raised junction 32 connecting a long edge of the vertical radiating section 41 and a free end of the base 31. The base 31 defines a first feeding point 311 adjacent to the first grounding point 111. A bottom edge of base 31 is substantially at the same level with the bottom transverse edge 11d of the first grounding plate 11. The raised junction 32 defines a drop height between the vertical radiating element 40 and the first grounding plate 11.

The second grounding plate 13 is of substantially rectangular shape and has two opposite third and fourth longitudinal edges 13a, 13c, and two opposite upper and lower transverse edges 13b, 13d substantially perpendicularly connected to the third and fourth longitudinal edges 13a and 13c. The linking portion 12 connects a portion of the second longitudinal edge 11c of the first grounding plate 11 with a portion of the third longitudinal edge 13a of the second grounding plate 13 which is spaced parallel to the second longitudinal edge 11c. The second grounding plate 13 has two projecting pieces 131 respectively protruding upward from the upper transverse edge 13b and downward from the lower transverse edge 13d until a bottom edge thereof aligned with the bottom transverse edge 11d of the first grounding plate 11. The two projecting pieces 131 are adjacent to the third longitudinal edge 13a. The junction of the upper transverse edge 13b and the fourth longitudinal edge 13c is cut off to form an arc trace 132. A second grounding point 133 is disposed at a portion of the second grounding plate 13 adjacent to the upper transverse edge 13b.

The horizontal radiating element 70 is spaced at the upper transverse edge 13b of the second grounding plate 13 with a top edge of the horizontal radiating element 70 substantially at the same level with the top transverse edge 11b of the first grounding plate 11. A second connecting portion 50 extends slantwise from a portion of the upper transverse edge 13b and towards the fourth longitudinal edge 13c. A second feeding portion 60 extends towards the upper transverse edge 13b of the second grounding plate 13 from a bottom edge of the horizontal radiating element 70 and terminates to a free end of the second connecting portion 50 for connecting the horizontal radiating element 70 with the second connecting portion 50. The second feeding portion 60 defines a second feeding point 61 adjacent to the second grounding point 133.

Structures of the cambered radiating section 42, the raised junction 32 and the arc trace 132 described above are shaped for adapting the dual-polarized antenna 100 to the interior space of an electronic product and installing the dual-polarized antenna 100 to the electronic product easily. Furthermore, the raised junction 32 can prevent the vertical radiating element 40 from rising up when assembled it to the electronic product.

The vertical radiating section 41 and the first grounding plate 11 are parallel to each other to form a simulation capacitance therebetween. The horizontal radiating element 70 and the second grounding plate 13 are parallel with each other to form a simulation capacitance therebetween. Both of the two simulation capacitances can tune the bandwidth and input the impedance of the dual-polarized antenna 100 to realize the impedance matching between the dual-polarized antenna 100 and the feeding cables (not shown) for decreasing the backwash effect and boosting the gain of the dual-polarized antenna 100.

The first connecting portion 20, the first feeding portion 30 and the vertical radiating element 40 corporately form a vertically polarized portion. The antenna characteristics of the vertically polarized portion and the grounding plate 10 are similar to a planar inverted-F antenna resonating at a frequency band of about 2.4 GHz. The second connecting portion 50, the second feeding portion 60 and the horizontal radiating element 70 collectively compose a horizontally polarized portion. The antenna characteristics of the horizontally polarized portion and the grounding plate 10 are similar to another planner inverted-F antenna also resonating at a frequency band of about 2.4 GHz. Both of the lengths of the horizontally and the vertically polarized portions are substantially equal to a quarter of wavelength with respect to the frequency band of about 2.4 GHz.

The linking portion 12 connects up the first grounding plate 11 and the second grounding plate 13, which not only avoids a reduced efficiency of the horizontally and the vertically polarized portions caused by a complete detachment between the first grounding plate 11 and the second grounding plate 13, but also helps to decrease a interference between the horizontally polarized portion and the vertically polarized portion on account of a utter connection between the first grounding plate 11 and the second grounding plate 13.

When the dual-polarized antenna 100 is used for wireless communications, the horizontally polarized portion resonates at a frequency range covering 2.4-2.5 GHz to correspond to horizontally polarized electromagnetic waves of the Wireless Fidelity (WIFI), the vertically polarized portion operates at a frequency range covering 2.4-2.5 GHz to correspond to vertically polarized electromagnetic waves of the WIFI. The horizontally polarized portion and the vertically polarized portion are complementary to each other, which helps to improve the gain of the dual-polarized antenna 100.

As described above, the first connecting portion 20, the first feeding portion 30 and the vertical radiating element 40 corporately form the vertically polarized portion. The second connecting portion 50, the second feeding portion 60 and the horizontal radiating element 70 together constitute the horizontally polarized portion. The horizontally polarized portion and the grounding plate 10, the vertically polarized portion and the grounding plate 10 respectively form a planar inverted-F antenna resonating at a frequency range covering 2.4-2.5 GHz, so that the dual-polarized antenna 100 can receive and transmit the electromagnetic waves of the WIFI. The two simulation capacitances, one of which formed between the vertical radiating section 41 and the first grounding plate 11 and the other one formed between the horizontal radiating element 70 and the second grounding plate 13, can adjust bandwidth of the dual-polarized antenna 100 and better the gain of the dual-polarized antenna 100, so as to improve the property and the efficiency of the dual-polarized antenna 100.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A dual-polarized antenna, comprising:
a grounding plate;
a vertically polarized portion, the vertically polarized portion having a first connecting portion extending from one edge of the grounding plate, a vertical radiating element spaced at the edge for forming a simulation capacitance therebetween, and a first feeding portion connected to the first connecting portion and the vertical radiating element; and
a horizontally polarized portion, the horizontally polarized portion having a second connecting portion extending from another edge of the grounding plate substantially perpendicular to the edge of the grounding plate, a horizontal radiating element spaced at the another edge for forming a simulation capacitance therebetween, and a second feeding portion connected to the second connecting portion and the horizontal radiating element.

2. The dual-polarized antenna as claimed in claim 1, wherein the grounding plate includes a first grounding plate, a second grounding plate spaced at the first grounding plate, the first grounding plate has two opposite first and second longitudinal edges and two opposite top and bottom transverse edges, the second grounding plate has two opposite third and fourth longitudinal edges and two opposite upper and lower transverse edges, a narrow linking portion connects a portion of the second longitudinal edge with a portion of the third longitudinal edge which is spaced parallel to the second longitudinal edge.

3. The dual-polarized antenna as claimed in claim 2, wherein the first connecting portion extends slantwise from a lower position of the first longitudinal edge and towards the bottom transverse edge which is adjacent and substantially perpendicular to the first longitudinal edge.

4. The dual-polarized antenna as claimed in claim 3, wherein the vertical radiating element has a vertical radiating section with a top end thereof defining a cambered radiating section bent towards the first longitudinal edge of the first grounding plate and a bottom end thereof exceeding the bottom transverse edge of the first grounding plate.

5. The dual-polarized antenna as claimed in claim 2, wherein the seconding feeding portion extends slantwise from a portion of the upper transverse edge and towards the fourth longitudinal edge which is adjacent and substantially perpendicular to the upper transverse edge.

6. The dual-polarized antenna as claimed in claim 5, wherein a junction of the upper transverse edge and the fourth longitudinal edge of the second grounding plate is cut off to from an arc trace.

7. The dual-polarized antenna as claimed in claim 2, wherein the first grounding plate defines a first grounding point at a corner defined by the first longitudinal edge and the bottom transverse edge, the first feeding portion defines a first feeding point adjacent to the first grounding point.

8. The dual-polarized antenna as claimed in claim 2, wherein the second grounding plate defines a second grounding point adjacent to the upper transverse edge, the second feeding portion defines a second feeding point adjacent to the second grounding point.

9. The dual-polarized antenna as claimed in claim 1, wherein the first feeding portion has a base extending towards the vertical radiating element from a free end of the first connecting portion and a raised junction connecting a long edge of the vertical radiating element and a free end of the base.

10. The dual-polarized antenna as claimed in claim 9, wherein the raised junction defines a drop height between the vertical radiating element and the first grounding plate.
